(19) United States
(12) Patent Application Publication
(10) Pub. No.: US 2017/0293270 A1
(43) Pub. Date: Oct. 12, 2017

(54) LEARNING SYSTEM FOR EFFICIENT SUN-BLINDS CONTROL

(71) Applicant: Honeywell International Inc., Morris Plains, NJ (US)

(72) Inventors: Karel Marik, Revnice (CZ); Zdenek Schindler, Praha (CZ); Ondrej Holub, Prague (CZ)

(21) Appl. No.: 15/093,860

(22) Filed: Apr. 8, 2016

(51) Int. Cl. G05B 13/02; E06B 9/38

(52) U.S. Cl. CPC G05B 13/0265; E06B 9/38; E06B 2009/6818

(57) ABSTRACT

A sun blinds system for light conditions control in a room or space. The space or room with one or more windows may have a set of sun blinds that have a position to cover the whole or part of the window to prevent to an extent, as desired by an occupant or occupants, sunlight from entering the space. Parameters such as space light level, glare, weather conditions, time of year and day, cloud cover, space temperature and occupancy may be entered in a database. A learning supervisor may determine the position of the sun blinds in view of the parameters and previous manual sun blinds' settings by occupants, and provide the position to a sun blinds controller.

### BACKGROUND

The present disclosure pertains to illumination levels in a space and ways of controlling the illumination levels.

### SUMMARY

The disclosure reveals a sun blinds control system. A space or room with one or more windows may have a set of sun blinds that have a position to cover the whole or part of the window to prevent to an extent, as desired by an occupant or occupants, sunlight from entering the space. Parameters such as space light level, glare, weather conditions, time of year and day, cloud cover, space temperature and occupancy may be entered in a database. A learning supervisor may determine the position of the sun blinds in view of the parameters and previous manual sun blinds' settings by occupants, and provide the position to a sun blinds controller.

### BRIEF DESCRIPTION OF THE DRAWING

FIG. 1 is a diagram of an example sun blinds layout;

FIG. 2a is a diagram of the sun relative to an illustrative set of horizontal blinds;

FIG. 2b is a diagram of the sun relative to an illustrative set of vertical blinds;

FIG. 3 is a diagram of a map that reveals an annual path of the sun through the sky for a particular location on earth;

FIG. 4a is a diagram of a user or occupant in an office space having a window through which sun rays enter the space;

FIG. 4b is a diagram of the user or occupant in an office that may have blinds to remove discomforting sun rays from the occupant's face;

FIG. 4c is a diagram of the office space that permits an entry of sufficient light into space for carrying on office tasks with blinds that may be adjusted manually or by a controller;

FIG. 5 is a diagram of a space having an elaborate blinds control system; and

FIG. 6 is a diagram of a supervisor that incorporates a sun blinds position model.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

The present system may be focused on advanced room control systems which integrate blinds into room automation. A blinds position control may be a multi-objective task. The blinds position control may involve 1) glare protection, 2) space light level control, 3) privacy protection, 4) personal preference for visual contact with exterior, and 5) control of solar heat gains.

Algorithms may take into account individual preferences of occupants in the space that the blinds are to serve.

In particular, subjective and contradictory occupant's preferences that are difficult to weigh may incorporate sensitivity to glare around a work-space, a personal light level preference, an importance of privacy protection (an occupant's desire not to be seen), and an importance of visual contact with exterior (an occupant's desire to see the outside).

The present system may solve such issues by continuous learning of occupant preferences. The system may observe occupant resets of a sun blinds' position and then repeat the same position in the same (or similar) conditions.

The system may incorporate the following workflows. In a first workflow, an occupant reset may trigger an update to a list of occupant or user preferences. The terms “user” and “occupant” may be used interchangeably. An update may be triggered also by significant change of conditions even without a reset. This may be however similar to the second workflow, a learning activity. The list may incorporate preference-condition pairs. Depending on the conditions of a reset, either a new item may be introduced to the list, or preferences of an existing item may be updated.

In a second workflow, an application of the learned model of preferences, conditions may be continuously monitored using available (measured) quantities and grouped together based on their similarity. Grouping on this level may be not necessary. In one implementation of the controller that uses a learning algorithm, a group of past situations (represented by conditions) similar to a current situation may be retrieved from the database and used for derivation of a pertinent response any time it is necessary for control.

If a current condition or conditions are found to be sufficiently similar to an entry in the list of preference-condition pairs, then the blinds may be reset to the corresponding occupant-preferred position. Current conditions may be compared with the stored past conditions. Preferences from the past relevant pairs that have similar conditions may be used to derive (e.g., by interpolation) a new position of the sun blinds.

If a sufficient number of similar situations is not found, a result of such search cannot necessarily be used to get sufficiently decisive priorities for the decision—the result does not appear adequately representative. Then the controller may apply a default positioning or it might intervene and leave the decision on the occupant. If the sun blinds positions are retrieved from the database, newer pairs may get higher weight in the decision process.

A condition similarity may be defined using measurable quantities such as 1) sun position, 2) solar irradiation (depending on cloud cover), and 3) a time-of-day. The sun position may be a simple function of building location (ZIP code) and time. Solar irradiation may be either measured (e.g., once per building/facade) or estimated using data from illumination sensors (e.g., lamps with integrated illumination sensors).

The present system may be used by one occupant as well as by multiple occupants. In a case where individual occupants can be distinguished (e.g., using a smartphone interface to control the blinds), then occupant or user preferences in the list may be stored uniquely for each occupant or user, and the blinds position may be chosen to satisfy a largest number of occupants or to irritate the least number of occupants (using, e.g., a smartphone to learn a presence of the occupants). A preference of an occupant may be a position of sun blinds for certain conditions (e.g., sun position, sky cover, time of the day, day of the week, and so on). Preferences of different occupants or users may be assigned various weights in a decision process.

Several advantages of the present system which stem from its adaptive nature may incorporate true personal occupant's preferences. An occupant may be able to easily influence a blinds position. There may be a low setup complexity (i.e., there should be no need to provide external shading profiles for a working place location or to define complex blinds control rules).

Even though the present system does not necessarily solve all aspects of sun-blinds control, it may address a very difficult part that is to be derived from personal human preferences.

The system can be used within a portfolio of integrated room controllers (IRC) or integrated room managers (IRM).

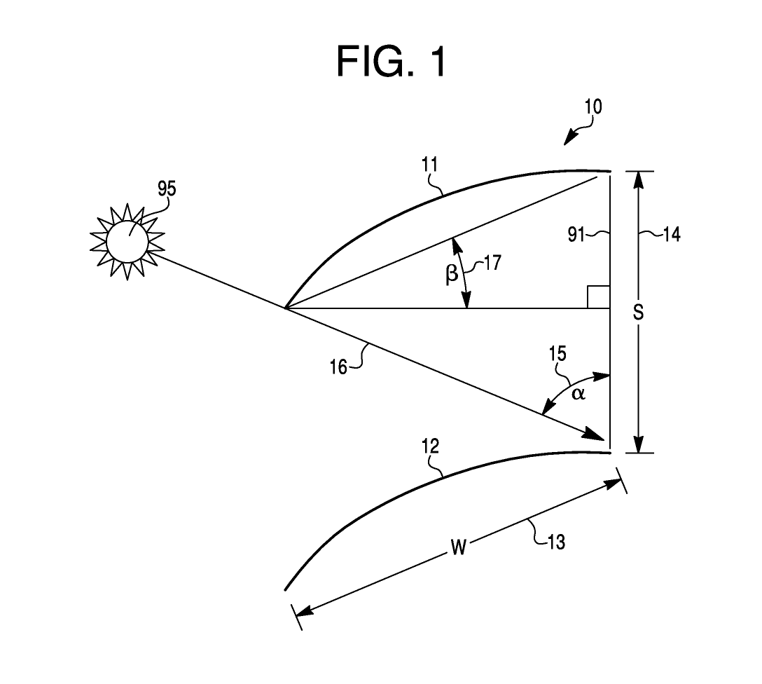

The present system and approach may provide glare protection from sunlight in, for instance, an office. Blinds may be used to reduce direct sunlight glare. An example blinds 10 layout is shown in a diagram of FIG. 1. Setting the blinds angle may be based on blade geometry. The terms “slat” and “blade” may be used interchangeably. There may be shadow edge tracking with dynamic adjustment of slats 11 and 12. Each slat, 11 and 12, may have an example width (w) 13 of 47 mm and an example distance (s) 14 between slats 11 and 12 of 44 mm. Just two slats may be considered for the present illustration. Virtually any practical number above two slats may be used for a set of blinds. Angle alpha 15 may be of a sun light ray plane 16 relative to a plane 91 encompassing the blinds 10.

Angle (B) 17 may be an angle of the slats 11 and 12 relative to the direction facing blinds 10 perpendicular to a plane parallel to the blinds. A preference of an occupant may be a position of sun blinds for certain conditions (i.e., sun position, sky cover, time of the day, day of the week, and so forth. This angle may determine shading of the blinds. It may prevent direct sun rays from glaring as well as determine the portion of the sun blinds through which outside light gets in. One may use angles between planes, such as an angle of a slats' plane (e.g., of slats 11 or 12 in FIG. 1) and the plane defined by a slat's edge perpendicular to a plane of the blinds (parallel to the blinds).

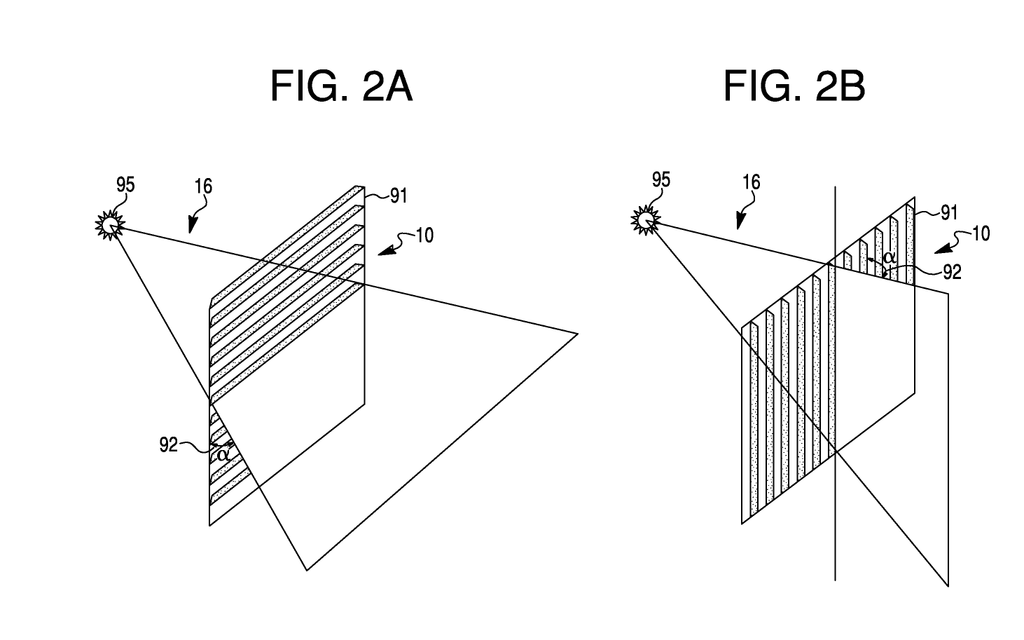

FIG. 2a and FIG. 2b reveal an angle 92 that may be between the plane 91 of blinds (i.e., a plane parallel to blinds) and a plane 16 defined by the sun 95 and the straight line of a blade edge. The angle may play a role in shading for both horizontal and vertical blades. Angle alpha 92 may be shown to be between a plane of sunlight and a plane parallel to a set of blinds indicating a decisive position of the sun relative to different types of sun blinds such as horizontal and vertical blinds, respectively.

The present system does not necessarily work with angles. A controller may just repeat actions of an occupant. The occupant does not necessarily know angles, but may just position the blinds until the occupant is satisfied. The controller may repeat the same positions in the similar conditions. It may be impossible for the controller to find the same conditions in the past. Therefore, the controller may seek similar past conditions and derive the current sought position from them, e.g., by interpolation from past positions in similar conditions.

Some information to note is that a blinds (slats) angle (B) 17 in FIG. 1 may be based on blade geometry. Sun position may be regarded as an absolute position on the sky or a relative position with regard to a blind.

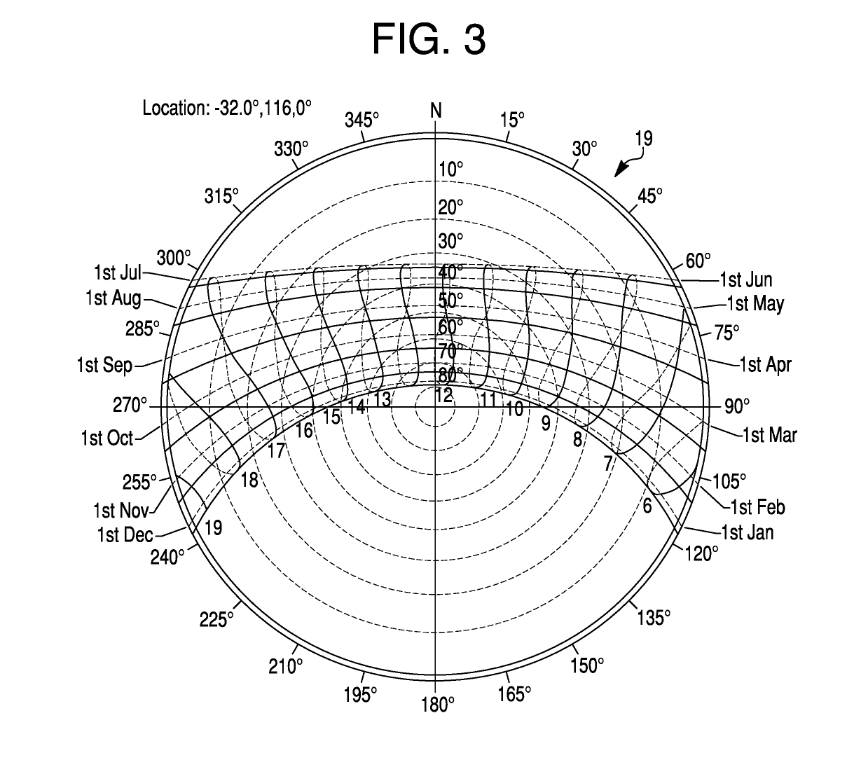

Sun position, blinds geometry and an external sunny/cloudy conditions may be utilized. There may be an external shading profile and a working place location. FIG. 3 is a diagram that reveals a map 19 showing an annual path of the sun through the sky for a particular location on earth. An instance of location shown in FIG. 3 may have earth coordinates of negative 32.0 degrees and positive 116.0 degrees. Thus, a position of the sun may be known from the calendar day and time. Also, simple mathematical expressions may be used to determine sun position.

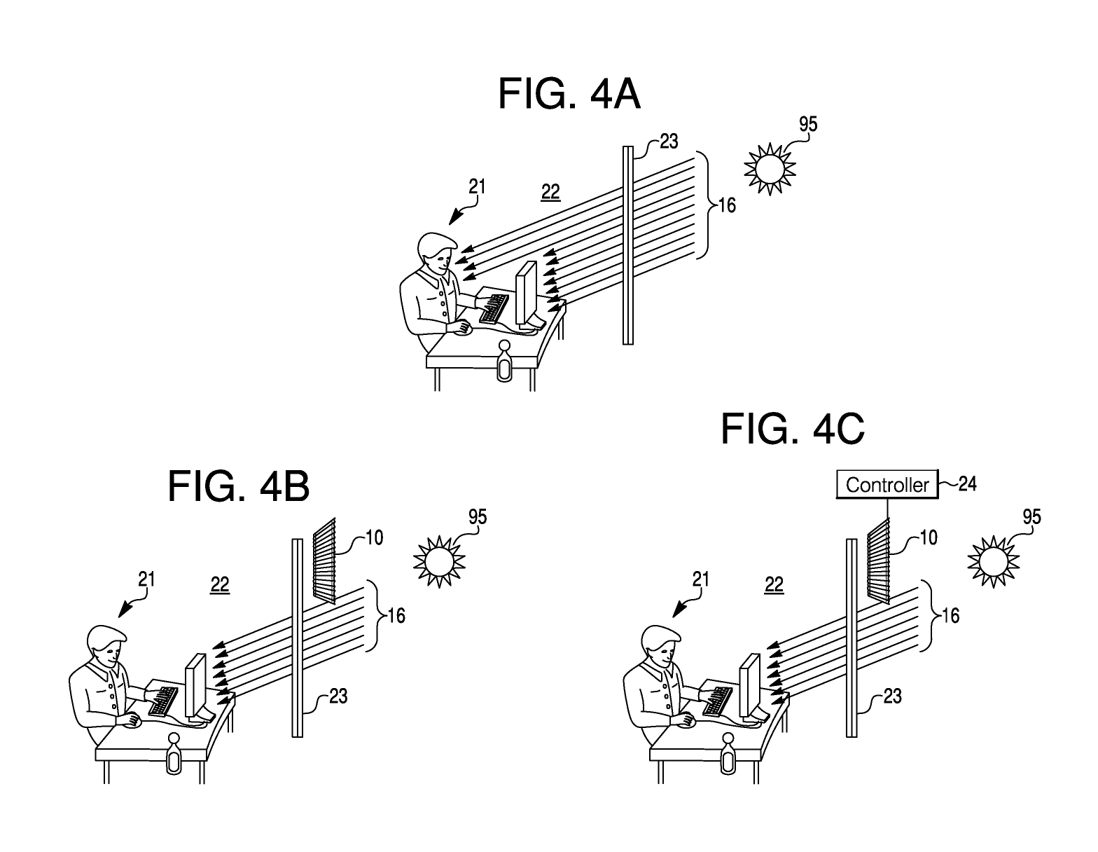

The blinds position (i.e., slat angle (B) 17, the length of shaded part of the window, which can be seen, e.g., on FIG. 4b, as the length of part 10) may be determined by an occupant in a space having blinds 10. A controller may remember the blinds position and repeat it for a same sun position of another day. A prerequisite for a blinds 10 position determination may incorporate sun position, an external sun/cloud sensor and a blinds 10 position controller user interface.

A user may influence a blade position of blinds 10 in response to experienced discomfort. FIG. 4a is a diagram of a user or occupant 21 in an office space 22 having a window 23 through which light of sun 95 enter space 22. Occupant or user 21 may experience a discomfort from sun rays 16 or a plane 16 of sun light (i.e., some sort of wide beam (or something like that) coming through unshaded part of the window and/or through narrow or wide spaces between slats) impinging an occupant's face. Occupant 21 may manually adjust blinds 10 to remove the discomfort of sun light 16 to the occupant's face, and still permit an entry of sufficient light into space 22 for carrying on office tasks, as shown in a diagram of FIG. 4b. In a diagram of FIG. 4c, an adjusted blinds 10 position of FIG. 4b may be repeated for the same conditions such as sun position. The blinds 10 position may be automatically repeated or adjusted by a controller 24 having a program that is provided information relative to space 22, user 21, sun 95, blinds 10 geometry, and user 21 influence as needed or desired.

The slats or blades of the sun blinds may be situated horizontally, vertically or at another angle relative to the earth's surface.

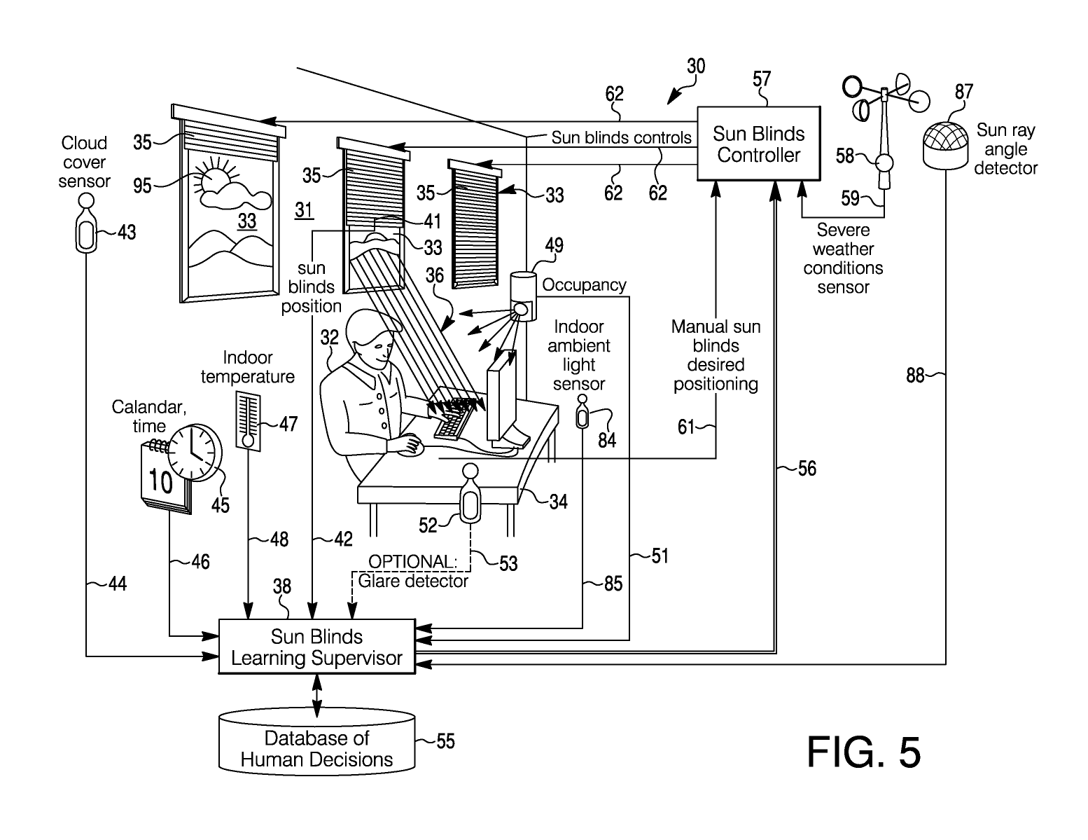

FIG. 5 is a diagram of a more elaborate blinds control system 30. In a space 31 (a single place—a work place of the occupant), there may be a user 32 at a workstation 34. Space 31 may have several windows 33. Each window 33 may have a set of blinds 35 with actuators. Sun rays 36 of sun 95 may enter space 31 and impinge workstation 34 and possibly affect a working environment of user 32. User 32 may chose a kind of light, such as sun rays 36, which should enter space 31.

A sun blinds learning supervisor 38 may receive numerous inputs that are pertinent to sun blinds positions. Signals 42 may come from a sensor 41 indicative of a position of sun blinds 35 at windows 33, to supervisor 38. A cloud cover sensor 43 may provide sky condition signals 44 to supervisor 38. A calendar and clock 45 may provide date and time signals 46 to supervisor 38. An indoor thermometer 47 may provide temperature signals 48 about space 31 to supervisor 38. An occupancy sensor 49 may provide signals 51, about whether space 31 is occupied, and if so, how many occupants are in space 31, to supervisor 38. An ambient light level sensor 84 may provide light level information signals 85 about space 31 to supervisor 38. A sun ray angle detector 87 may provide an angle of direct rays from the sun relative to a reference as signals 88 to supervisor 38. If detector 87 is not installed, its signal can be substituted by indoor ambient light sensor, which may provide actual information about illumination at the workplace. Signals 88 may indicate a height or angle of the sun relative to the horizon. A glare detector 52 may provide information signals 53 about glare at workstation 34 in space 31 to supervisor 38. Glare detector 52 may be optional. Supervisor 38 may be connected to a database 55 containing information about human decisions relative to light conditions in space 31 and at workstation 34. Output signals 56 indicating a blinds position may go to a sun blinds controller 57. A severe weather conditions sensor 58 may provide signals 59 about weather conditions to controller 57. However, sensor 58 may be an item for protecting blinds from damage and is not necessarily a part of the present system. Signals 61 indicating manual sun blinds desired positioning may be sent by user 32 to controller 57. Controller 57 may provide to the actuators of sun blinds 35 control signals 62 of desired position and angle of sun blinds 35.

Possible implementations of the more elaborate blinds control system 30 may also integrate the learning supervisor 38 and the sun blinds controller 57 in a single control system. Learning supervisor 38 may be distributed in the building automation system in different ways which include, among others, a code embedded in room controllers, an algorithm run at a building-supervisor level, an application for mobile devices, or a cloud-based service.

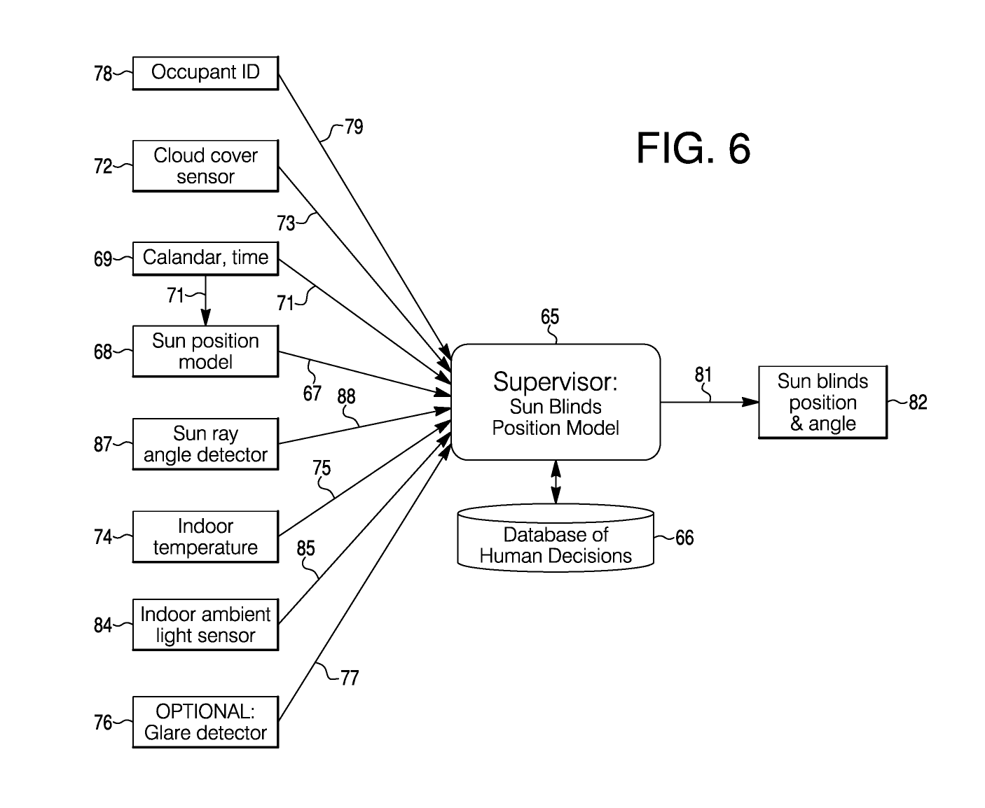

FIG. 6 is a diagram of a supervisor 65 that contains a sun blinds position model. A database 66 of human decisions and related conditions, may be connected to supervisor 65. Signals 67 may provide information about a sun position using model 68 to supervisor 65. An alternative to a model for determination of the sun position may be a use of a processed signal 88 from the sun ray angle detector 87. A calendar and time module 69 may provide date and time signals 71 to sun position model 68 and to supervisor 65. A cloud cover sensor 72 may provide cloud information signals 73 to supervisor 65. A sensor 74 may provide indoor temperature signals 75 to supervisor 65 of an occupant's space to supervisor 65. An indoor ambient light sensor 84 may provide light information signals 85 to supervisor 65. A sun ray or plane angle detector 87 may provide an angle of direct rays from the sun relative to a reference as signals 88 to supervisor 65. A glare detector 76 may provide sun glare information signals 77 to supervisor 65. Detector 76 may be optional.

An occupant 78 of a space may provide identification signals 79 to supervisor 65. Output signals 81 from supervisor 65 may provide position and angle control information 82 for a set of actuators connected to a set of sun blinds.

A database may contain pairs—past conditions coupled with past positions that are satisfactory for the occupant or occupants. The past positions may have been set manually or automatically by the controller in particular conditions. They may represent past satisfactory settings (accepted decisions in particular situations).

In normal operation after a learning phase, the controller “every minute” may derive a current sun blinds position from current conditions using the past condition-position pairs and send it to the sun blinds controller for actuation. If the user is not satisfied, the user may change the current position manually. The controller may register this intentional change (overwrite) in the database as a new case and if the user's dissatisfaction with controller's action in similar situations repeats, the controller may start to response in a different new way, satisfactory for the user. From now on, the controller may set the position according to the new user's preference. The new pairing may dominate over the old one, if it appears sufficiently often. The old pairing may be forgotten.

To recap, a blinds position control system may incorporate sun blinds, an actuator connected to the sun blinds, a blinds controller connected to the actuator, a human interface connected to the blinds controller, a learning supervisor connected to the blinds controller, and a database of human decisions, connected to the learning supervisor. The sun blinds may incorporate a plurality of blades. The plurality of blades may have an adjustable blade angle which can be changed by the actuator. The sun blinds may have an adjustable area for at least partially blocking light determined by a position of the sun blinds, which can be changed by the actuator.

The plurality of blades may have a dynamic adjustment of the blade angle to alter an amount direct sunlight passing through the sun blinds.

The sun blinds may have a dynamic adjustment of area to alter an amount of blockage of light as effected by the actuator as determined by a signal from the sun blinds controller.

The system may further incorporate one or more devices connected to the learning supervisor. The one or more devices may be selected from a group incorporating an indoor thermometer, a calendar and time indicator, an indoor occupancy detector, a cloud cover sensor, a severe weather conditions sensor, an indoor ambient light level sensor, a sun blinds position sensor, and a glare detector.

The database may incorporate a control signal, derived from past records having past positions in particular conditions, which may go from the learning supervisor to the blinds controller.

The human interface may incorporate a manual sun blinds position input mechanism connected to the blinds controller.

The human interface may be selected from a group incorporating smartphones, pads, notebooks, laptops, computers, and controllers. The interface may be used to manually control the sun blinds.

Human decisions relative to sun blinds settings of positions by one or more humans may be stored in the database of human decisions.

A sun ray or plane angle for each day may be predetermined according to a calendar day and a time during the calendar day.

A human may manually provide an adjustment of the sun blinds, incorporating the blade angle and an amount of coverage over a window by the sun blinds as indicated by a position of the sun blinds, to remove one or more discomforts caused by sunlight. The manual adjustment, together with conditions in the occupied space represented by data from sensors at inputs of the learning supervisor, may be automatically recorded in the database of human decisions and repeated under similar conditions, incorporating sun positions in the sky, on subsequent days.

An approach of blinds control in a space, may incorporate measuring an actual amount of sunlight entering the space, determining a desirable amount of sunlight entering the space for an occupant, adjusting a position of blinds in terms of coverage over a window and an angle of slats of the blinds relative to a geometrical plane that the blinds lie in, to achieve the desirable amount of sun light entering the space at a given sun ray or plane angle, entering the position of the blinds and the angle of the slats into a database containing user decisions for the given sun angle, and adjusting the blinds for the given sun angle according to an entry in the database according to occupants' decisions.

Adjusting of blinds for the given sun angle according to an entry in the database of occupants' decisions may be automatic.

An automatic adjusting of the blinds for the given sun angle according to an entry in the database of occupants' decisions may be overridden by an occupant with a manual adjusting of the blinds.

Information may be provided to the database from one or more devices selected from a group incorporating an indoor thermometer, a calendar and time indicator, an indoor occupancy detector, a cloud cover sensor, a severe weather conditions sensor, an indoor ambient light level sensor, a blinds position sensor, a glare detector, and a sun ray angle detector.

The manual adjusting the blinds may be effected remotely by a smartphone, pad, notebook, laptop, computer, or a wired or wireless controller.

A blinds operating mechanism may incorporate an actuator, a controller connected to the actuator, a supervisor connected to the controller, one or more sensors connected to the supervisor, and sun blinds covering one or more windows in a space connected to the actuator. The actuator may adjust the sun blinds according to control signals from the controller.

The supervisor may be connected to a room automation system.

The mechanism may further incorporate a database of occupant decisions. Occupant decisions may be recorded in the database, which are actions or adjustments pertaining to the sun blinds effected by one or more occupants in the space. A reset may update the database of occupant decisions. The occupant decisions may depend on one or more items selected from a group incorporating glare amounts, light levels, visual privacy from an exterior of the space, visual contact with the exterior of the space, and solar heat gains in the space.

Occupant decisions may be stored uniquely for each occupant. A sun blinds position may be selected from the occupant decisions that satisfy a largest number of occupants or irritate a least number of occupants. Each occupant and the respective occupant's decision may be assigned a weight. Then weighted past decisions may be respected in the current decision process for determining the sun blinds position.

An adjustment of the sun blinds may incorporate an area covering of the one or more windows in the space and an angle of slats relative to a plane of the corresponding one or more windows.

An input to the supervisor and the database may have or receive one or more signals from one or more components providing information selected from a group incorporating sun ray angle, position of the sun as known by a calendar day and a time of the calendar day, indoor temperature, occupancy of the space, cloud cover, severe weather, indoor light level, glare, a percentage of a window in the space covered by the sun blinds, and an angle of the slats of the sun blinds relative to a planar surface of the window.

Any publication or patent document noted herein is hereby incorporated by reference to the same extent as if each publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A blinds position control system comprising:
sun blinds;
an actuator connected to the sun blinds;
a blinds controller connected to the actuator;
a human interface connected to the blinds controller;
a learning supervisor connected to the blinds controller; and
a database of human decisions, connected to the learning supervisor; and
wherein:
the sun blinds comprise a plurality of blades;
the plurality of blades has an adjustable blade angle which can be changed by the actuator; and
the sun blinds have an adjustable area for at least partially blocking light determined by a position of the sun blinds, which can be changed by the actuator.

2. The system of claim 1, wherein the plurality of blades has a dynamic adjustment of the blade angle to alter an amount direct sunlight passing through the sun blinds.

3. The system of claim 1, wherein the sun blinds have a dynamic adjustment of area to alter an amount of blockage of light as effected by the actuator as determined by a signal from the sun blinds controller.

4. The system of claim 1, further comprising:
one or more devices connected to the learning supervisor; and
wherein the one or more devices are selected from a group comprising an indoor thermometer, a calendar and time indicator, an indoor occupancy detector, a cloud cover sensor, a severe weather conditions sensor, an indoor ambient light level sensor, a sun blinds position sensor, and a glare detector.

5. The system of claim 4, wherein parameters from the one or more devices play a role in a decision by an occupant on a position of the sun blinds.

6. The system of claim 1, wherein the database comprises a control signal, derived from past records incorporating past positions in particular conditions, which goes from the learning supervisor to the blinds controller.

7. The system of claim 1, wherein the human interface comprises a manual sun blinds position input mechanism connected to the blinds controller.

8. The system of claim 7, wherein:
the human interface is selected from a group comprising smartphones, pads, notebooks, laptops, computers, and various wired and wireless controllers; and
the interface is used to manually control the sun blinds.

9. The system of claim 1, wherein human decisions relative to sun blinds settings of positions by one or more humans are stored in the database of human decisions.

10. The system of claim 1, wherein:
a human can manually provide an adjustment of the sun blinds, incorporating the blade angle and an amount of coverage over a window by the sun blinds as indicated by a position of the sun blinds, to remove one or more discomforts caused by sunlight; and
the manual adjustment, together with conditions in the occupied space represented by data from sensors at inputs of the learning supervisor, is automatically recorded in the database of human decisions and repeated under similar conditions, incorporating sun positions in the sky, on subsequent days.

11. A method of blinds control in a space, comprising:
making a decision on a position of blinds in terms of coverage over a window and an angle of slats of the blinds relative to a geometrical plane that the blinds lie in, to achieve a desirable amount of sun light entering the space at a given sun angle;
entering the position of the blinds and the angle of the slats into a database containing occupants' decisions for the given sun angle; and
setting the blinds for the given sun angle according to an entry in the database according to occupants' decisions.

12. The method of claim 11, wherein the setting of blinds for the given sun angle according to an entry in the database of occupants' decisions is automatic.

13. The method of claim 12, wherein an automatic setting of the blinds for the given sun angle according to an entry in the database of occupants' decisions can be overridden by an occupant with a manual adjusting of the blinds.

14. The method of claim 11, wherein information is provided to the database from one or more devices selected from a group comprising an indoor thermometer, a calendar and time indicator, an indoor occupancy detector, a cloud cover sensor, a severe weather conditions sensor, an indoor ambient light level sensor, a blinds position sensor, a glare detector, and a sun ray angle detector.

15. The method of claim 13, wherein the manual setting the blinds is effected remotely by a smartphone, pad, notebook, laptop, computer, or wired or wireless controller.

16. A blinds operating mechanism comprising:
an actuator;
a supervisor connected to the actuator;
one or more sensors connected to the supervisor; and
sun blinds covering one or more windows in a space connected to the actuator; and
wherein the actuator adjusts the sun blinds according to control signals directly from the supervisor.

17. The mechanism of claim 16, wherein the supervisor is connected to a room automation system.

18. The mechanism of claim 16, further comprising:
a database of occupant decisions; and
wherein:
occupant decisions are recorded in the database, which are actions or adjustments pertaining to the sun blinds effected by one or more occupants in the space;
a reset updates the database of occupant decisions; and
the occupant decisions depend on one or more items selected from a group comprising glare amounts, light levels, visual privacy from an exterior of the space, visual contact with the exterior of the space, and solar heat gains in the space.

19. The mechanism of claim 16, wherein:
occupant decisions are stored uniquely for each occupant;
a sun blinds position is selected from the occupant decisions that satisfy a largest number of occupants or irritate a least number of occupants;
each of the occupant decisions is assigned a weight to establish a weighted occupant decision; and
weighted occupant decisions are considered in a decision process for selection of a sun blinds position.

20. The mechanism of claim 18, wherein an input to the supervisor and the database has or receives one or more signals from one or more components providing information selected from a group comprising sun angle, position of the sun as known by a calendar day and a time of the calendar day, indoor temperature, occupancy of the space, cloud cover, severe weather, indoor light level, glare, a percentage of a window in the space covered by the sun blinds, and an angle of the slats of the sun blinds relative to a planar surface of the window.
